(19) United States
(12) Patent Application Publication
(10) Pub. No.: US 2026/0331018 A1
(43) Pub. Date: Oct. 22, 2026

(54) GAMMA VOLTAGE GENERATION CIRCUIT AND SOURCE DRIVER CIRCUIT INCLUDING THE SAME

(71) Applicant: LX SEMICON CO., LTD., Daejeon (KR)

(72) Inventors: Dong Guk KIM, Daejeon (KR); Byeong Ho JEONG, Daejeon (KR)

(73) Assignee: LX SEMICON CO., LTD., Daejeon (KR)

(21) Appl. No.: 19/651,271

(22) Filed: Apr. 17, 2026

(30) Foreign Application Priority Data
Apr. 21, 2025 (KR) 10-2025-0051749

(51) Int. Cl. G09G 3/20; G09G 3/3275; G09G 3/36

(52) U.S. Cl. CPC G09G 3/2007; G09G 3/3275; G09G 3/3688; G09G 2310/0297; G09G 2320/0673

(57) ABSTRACT

The gamma voltage generation circuit includes a first voltage divider configured to output a plurality of voltages having; a multiplexer part configured to select upper gamma reference voltages and lower gamma reference voltages from the plurality of voltages; a first buffer part configured to transfer the selected upper and lower gamma reference voltages; a second voltage divider configured to output voltages between the upper and lower gamma reference voltages; a second buffer part configured to transfer gamma reference voltages from the voltages; and a third voltage divider configured to output grayscale voltages between the gamma reference voltages, the second buffer part includes a stabilizer configured to generate a sink current or a source current at an (N-1)th intermediate voltage-dividing node and an (N+1)th intermediate voltage-dividing node with respect to the Nth voltage-dividing node at which the Nth gamma reference voltage is output, whenever an input image changes.

### CROSS-REFERENCE TO RELATED APPLICATION

This application claims priority to and the benefit of Korean Patent Application No. 10-2025-0051749, filed on Apr. 21, 2025, the disclosure of which is incorporated herein by reference in its entirety.

### BACKGROUND

### Field

Embodiments of the present disclosure relate to a gamma voltage generation circuit and a source driver circuit including the same.

### Discussion of Related Art

With the development of an information technology society, demands for display devices for displaying images are increasing in various forms, and in recent years, various types of display devices, such as liquid crystal display devices (LCDs) and organic light-emitting display devices (OLEDs), have been utilized.

A display device includes a display panel including a plurality of pixels, a panel driver for driving the display panel, and the like. The panel driver includes a data driver for supplying data voltages to the display panel and a gate driver for supplying gate signals to the display panel.

The panel driver further includes a gamma voltage generation circuit for supplying gamma reference voltages to the data driver. Since the gamma voltages output from the gamma voltage generation circuit vary depending on an input image, the gamma voltages swing significantly whenever the input image changes, which in turn prolongs the settling time of an output signal.

### SUMMARY

The present disclosure is aimed at addressing the above-described needs and/or problems.

Embodiments of the present disclosure may provide a gamma voltage generation circuit and a source driver circuit including the same.

The problems of the present disclosure to be solved is not limited to the object mentioned above, and other objects not mentioned may be clearly understood by those skilled in the art from the following description.

A gamma voltage generation circuit according to an embodiment of the present disclosure includes: a first voltage divider configured to output a plurality of voltages having different voltage levels between a high-potential reference voltage and a low-potential reference voltage; a multiplexer part configured to select an upper gamma reference voltages and lower gamma reference voltages from the voltages divided by the first voltage divider; a first buffer part configured to transfer the upper and lower gamma reference voltages selected by the multiplexer part; a second voltage divider configured to output voltages having different voltage levels between the upper gamma reference voltage and the lower gamma reference voltages transferred by the first buffer part; a second buffer part configured to transfer gamma reference voltages from the voltages divided by the second voltage divider; and a third voltage divider configured to output grayscale voltages having different voltage levels between the gamma reference voltages transferred by the second buffer part, wherein the second buffer part may include a stabilizer configured to generate a sink current or a source current at an (N-1)th intermediate voltage-dividing node and an (N+1)th intermediate voltage-dividing node with respect to an Nth voltage-dividing node at which an Nth gamma reference voltage is output, whenever an input image changes.

The second buffer part may further include an output part configured to output the Nth gamma reference voltage through a first output node connected to the Nth voltage-dividing node, using a pull-up transistor controlled by a first control voltage and a pull-down transistor controlled by a second control voltage, and the stabilizer may include: a first transistor and a second transistor configured to generate the sink current or the source current through a second output node connected to the (N-1)th intermediate voltage-dividing node; and a third transistor and a fourth transistor configured to generate the sink current or the source current through a third output node connected to the (N+1)th intermediate voltage-dividing node.

The pull-up transistor, the first transistor, and the third transistor may be p-channel transistors, and the pull-down transistor, the second transistor, and the fourth transistor may be n-channel transistors.

The stabilizer may further include: a first comparator configured to convert the first control voltage into a first pulse wave and apply the converted first pulse wave to the first transistor and the third transistor; and a second comparator configured to convert the second control voltage into a second pulse wave and apply the converted second pulse wave to the second transistor and the fourth transistor. The first comparator and the second comparator may be Schmitt triggers.

The first transistor may include a gate electrode to which the first pulse wave is applied, a first electrode to which a high-potential voltage is applied, and a second electrode connected to the second output node, the second transistor may include a gate electrode to which the second pulse wave is applied, a first electrode connected to the second output node, and a second electrode to which a low-potential voltage is applied, the third transistor may include a gate electrode to which the first pulse wave is applied, a first electrode to which the high-potential voltage is applied, and a second electrode connected to the third output node, and the fourth transistor may include a gate electrode to which the second pulse wave is applied, a first electrode connected to the third output node, and a second electrode to which the low-potential voltage is applied.

The (N-1)th intermediate voltage-dividing node may be located between the Nth voltage-dividing node and the (N-1)th voltage-dividing node at which an (N-1)th gamma voltage is output, and the (N+1)th intermediate voltage-dividing node may be located between the Nth voltage-dividing node and the (N+1)th voltage-dividing node at which an (N+1)th gamma voltage is output.

The stabilizer may generate the sink current at each of the (N-1)th intermediate voltage-dividing node and the (N+1)th intermediate voltage-dividing node when the grayscale of the input image decreases.

The stabilizer may generate the source current at each of the (N-1)th intermediate voltage-dividing node and the (N+1)th intermediate voltage-dividing node when the grayscale of the input image increases.

A source driver circuit according to an embodiment of the present disclosure includes: a data driver configured to convert source data into data voltages based on gamma voltages; and a gamma voltage generation circuit configured to generate the gamma voltages, wherein the gamma voltage generation circuit includes: a first voltage divider configured to output a plurality of voltages having different voltage levels between a high-potential reference voltage and a low-potential reference voltage; a multiplexer part configured to select an upper gamma reference voltage and lower gamma reference voltages from the voltages divided by the first voltage divider; a first buffer part configured to transfer the upper and lower gamma reference voltages selected by the multiplexer part; a second voltage divider configured to output voltages having different voltage levels between the upper gamma reference voltage and the lower gamma reference voltages transferred by the first buffer part; a second buffer part configured to transfer gamma reference voltages from the voltages divided by the second voltage divider; and a third voltage divider configured to output grayscale voltages having different voltage levels between the gamma reference voltages transferred by the second buffer part, wherein the second buffer part may include a stabilizer configured to generate a sink current or a source current at an (N-1)th intermediate voltage-dividing node and an (N+1)th intermediate voltage-dividing node with respect to an Nth voltage-dividing node at which an Nth gamma reference voltage is output, whenever an input image changes.

According to the present disclosure, by causing a source current or a sink current to be generated at an (N-1)th intermediate voltage-dividing node and an (N+1)th intermediate voltage-dividing node with respect to an Nth voltage-dividing node at which a gamma reference voltage is output, depending on changes in an input image, the settling time for the Nth gamma reference voltage to return to its original voltage is shortened, and as a result, the settling time for an output voltage may also be shortened.

The effects of the present disclosure are not limited to the effects mentioned above, and other effects not mentioned may be clearly understood by those skilled in the art from the claims.

### BRIEF DESCRIPTION OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram illustrating a display device according to one embodiment of the present disclosure;

FIG. 2 is a block diagram illustrating a circuit configuration of the data driver shown in FIG. 1;

FIG. 3 is a diagram illustrating a circuit configuration of the gamma voltage generator shown in FIG. 1;

FIG. 4 is an equivalent circuit diagram illustrating a circuit configuration of the second buffer part shown in FIG. 3; and

FIGS. 5 to 8 are diagrams for explaining the operating principle of the stabilizer shown in FIG. 4.

### DETAILED DESCRIPTION OF EXEMPLARY EMBODIMENTS

The advantages and features of the present disclosure, and methods of achieving them will be apparent from the embodiments described in detail below in conjunction with the accompanying drawings. The present disclosure is not limited to the following embodiments, which may be implemented in various different forms; rather, the present embodiments are provided to make the disclosure of the present disclosure complete and to allow those skilled in the art to fully understand the scope of the present disclosure, and the present disclosure is defined only within the scope of the appended claims.

The shapes, sizes, proportions, angles, numbers and the like shown in the accompanying drawings for the purpose of describing the embodiments of the present disclosure are merely examples, and the present disclosure is not limited thereto. Like reference numerals generally denote like elements throughout the present specification. Further, in describing the present disclosure, detailed descriptions of known related technologies may be omitted so as not to unnecessarily obscure the subject matter of the present disclosure.

The terms such as "comprising," "including," "having," and "consisting of" used herein are generally intended to allow other components to be added unless the terms are used with the term "only." References to the singular shall be construed to include the plural unless expressly stated otherwise.

In the interpretation of components, they are construed to include margins of error, even if not explicitly stated.

When describing a positional or interconnected relationship between two components, such as "on~," "above~," "below~," "next to~," "connect or couple to~," "crossing," "intersecting," etc., one or more other components may be interposed between them unless "immediately" or "directly" is used.

When describing a temporal contextual relationship, such as "after~," "following~," "next to~," or "before~," it may not be continuous on a time scale unless "immediately" or "directly" is used.

First, second, and the like may be used before the names of the components to distinguish the components, but the function or structure thereof is not limited by such ordinal number or component name. For ease of description, the ordinal numbers placed before the names of the same components may differ between embodiments.

The following embodiments may be combined or associated with each other in whole or in part, and various types of interlocking and driving are technically possible. The embodiments may be implemented independently of one another or may be implemented together in an interrelated relationship.

Hereinafter, various embodiments of the present disclosure will be described in detail with reference to the accompanying drawings.

In the following embodiments, a transistor is a three-electrode element including a gate, a source, and a drain. In the case of an n-channel transistor, since carriers are electrons, the source voltage is lower than the drain voltage so that electrons can flow from the source to the drain. In the n-channel transistor, current flows from the drain to the source. In the case of a p-channel transistor (PMOS), since carriers are holes, the source voltage is higher than the drain voltage so that holes can flow from the source to the drain. In the p-channel transistor, since holes flow from the source to the drain, the current flows from the source to the drain. The source and drain of a transistor are not fixed. In the following description, the source and drain of a transistor will be referred to as first and second electrodes.

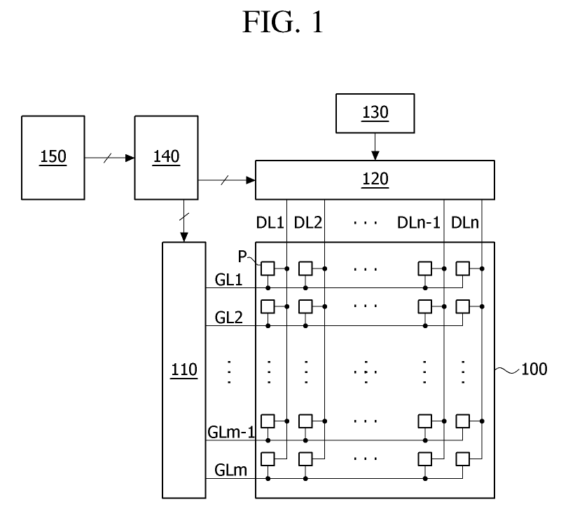

FIG. 1 is a block diagram illustrating a display device according to one embodiment of the present disclosure.

Referring to FIG. 1, the display device according to one embodiment of the present disclosure includes a display panel 100 and a display panel driving circuit for writing source data of an input image to pixels of the display panel 100. Source data may be interpreted as pixel data.

The display panel 100 may include a plurality of gate lines G1 to Gm and a plurality of data lines D1 to Dn that are arranged to intersect each other to define a plurality of pixel regions, and pixels P respectively provided in the plurality of pixel regions. Each of the pixels P may include a red sub-pixel R emitting red light, a green sub-pixel G emitting green light, and a blue sub-pixel B emitting blue light for color implementation. Each of the pixels P may further include a white sub-pixel. In a liquid crystal display device, pixels include liquid crystal cells. In an electroluminescent display device, pixels include light-emitting elements such as OLEDs. Each of the sub-pixels includes a pixel circuit for driving a liquid crystal cell or a light-emitting element.

The display panel driving circuit writes the source data of an input image to the pixels of the display panel 100 under control of a timing controller 140. The display panel driving circuit includes a source driver circuit for converting the source data into data voltages and a gate driver 110. The source driver circuit includes a gamma voltage generator 130 and a data driver 120.

The gate driver 110 may be disposed on one side, for example, the left side, of the display panel 100, but in some embodiments, it may be disposed on both one side and the other side of the display panel 100 facing each other, for example, on both the left side and the right side. The gate driver 110 may include a plurality of gate driver ICs (Gate Driver Integrated Circuits, not shown).

The gate driver 110 may be in the form of a tape carrier package on which gate driver ICs are mounted, but is not necessarily limited thereto, and the gate driver ICs may be directly mounted on the display panel 100.

The data driver 120 may receive source data of an input image received as a digital signal from the timing controller 140 and output data voltages. The data driver 120 may convert the source data of the input image into gamma voltages using a DAC (Digital to Analog Converter) and output data voltages.

The data driver 120 may be disposed on one side, for example, the upper side, of the display panel 100, but in some embodiments, it may be disposed on both one side and the other side of the display panel 100 facing each other, for example, on both the upper side and the lower side. In addition, the data driver 120 may be in the form of a tape carrier package on which source driver ICs are mounted, but is not necessarily limited thereto.

The gamma voltage generator 130 may generate a plurality of gamma voltages having different voltage levels, generate grayscale voltages using the generated gamma voltages, and provide the grayscale voltages to the data driver 120. A gamma voltage may be interpreted as a gamma reference voltage.

The timing controller 140 may receive various timing signals, including a vertical sync signal (Vsync), a horizontal sync signal (Hsync), a data enable (DE) signal, and a clock signal (CLK), from a host system 150, and may generate a data control signal (DCS) for controlling the data driver 120 and a gate control signal (GCS) for controlling the gate driver 110. In addition, the timing controller 140 may receive image data (RGB) from the host system 150 and convert and output it as image data (RGB') in a form processable by the data driver 120.

The data control signal (DCS) may include a source start pulse (SSP), a source sampling clock (SSC), and a source output enable signal (SOE). The gate control signal (GCS) may include a gate start pulse (GSP), a gate shift clock (GSC), and a gate output enable signal (GOE).

The host system 150 may be implemented as any one of a navigation system, a set-top box, a DVD (Digital Versatile Disc) player, a Blu-ray player, a personal computer (PC), a home theater system, a broadcast receiver, and a phone system.

The host system 150 may include a SoC (System on Chip) with a built-in scaler and may convert the digital image data (RGB) of the input image into a format suitable for display on the display panel 100. The host system 150 may transmit the digital image data (RGB) and the timing signals to the timing controller 140.

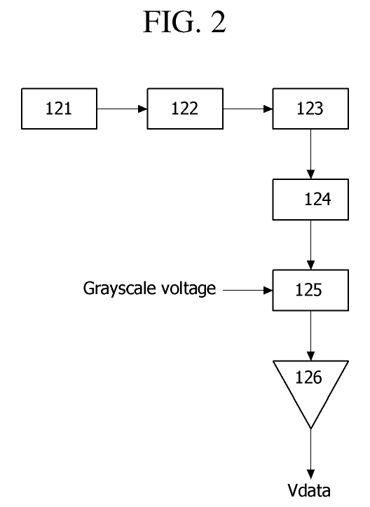

FIG. 2 is a block diagram illustrating a circuit configuration of the data driver shown in FIG. 1.

Referring to FIG. 2, the data driver 120 according to an embodiment of the present disclosure may include a receiver 121, a logic controller 122, a shift register 123, a latch 124, a DAC 125, and an output buffer 126.

The receiver 121 may receive data serially provided from the timing controller, recover a clock from the received data, and sample control data and source data of an input image from the data using the recovered clock.

The logic controller 122 may rearrange the source data on a sub-pixel basis. The logic controller 122 may control the output timing of the shift register and the latch using the clock and control data.

The shift register 123 may shift the clock input from the timing controller to generate a sampling clock, and may sequentially output the generated sampling clock to the latch (LAT).

The latch 124 may sample and store the source data in accordance with the timing of the sequentially input sampling clock, and may simultaneously output all the stored source data.

The DAC 125 may select a grayscale voltage corresponding to the grayscale value of the source data input from the latch 124 and output it as a data voltage. The grayscale voltage may be interpreted as a gamma compensation voltage for each grayscale level, and may be provided from the gamma voltage generator 130.

The output buffer 126 may amplify the data voltage input from the DAC 125 and output the amplified data voltage to a data line. The data voltage may increase as the grayscale of the source data increases and may decrease as the grayscale of the source data decreases.

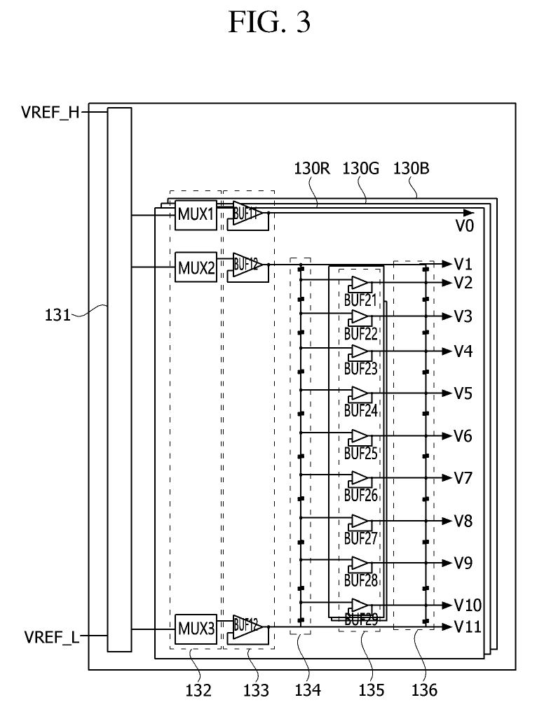

FIG. 3 is a diagram illustrating a circuit configuration of the gamma voltage generator shown in FIG. 1.

Referring to FIG. 3, the gamma voltage generator 130 according to an embodiment of the present disclosure may include a first voltage divider 131, a multiplexer (MUX) part 132, a first buffer part 133, a second voltage divider 134, a second buffer part 135, and a third voltage divider 136.

In this configuration, when implementing gamma voltage generation circuits for each color, the gamma voltage generator 130 may include a first gamma voltage generator 130R, a second gamma voltage generator 130G, and a third gamma voltage generator 130B, but is not limited thereto. The first gamma voltage generator 130R outputs gamma voltages for generating data voltages applied to red sub-pixels. The second gamma voltage generator 130G outputs gamma voltages for generating data voltages applied to green sub-pixels. The third gamma voltage generator 130B outputs gamma voltages for generating data voltages applied to blue sub-pixels.

The first voltage divider 131 may divide a voltage between a high-potential reference voltage VREF_H and a low-potential reference voltage VREF_L to output voltages having different voltage levels. For example, the first voltage divider 131 may include a plurality of resistors connected in series.

The first voltage divider 131 divides the voltage between the high-potential reference voltage VREF_H and the low-potential reference voltage VREF_L through voltage-dividing nodes, thereby generating voltages having different voltage levels.

The MUX part 132 may select upper gamma reference voltages V0 and V1 and a lower gamma reference voltage V11 from the voltages divided by the first voltage divider 131. For example, the MUX part 132 may be implemented as multiplexers.

The first buffer part 133 may transfer the upper and lower gamma reference voltages V0, V1, and V11 selected by the MUX part 132. For example, the first buffer part 133 may be implemented as buffers composed of operational amplification parts. The first buffer part 133 includes a non-inverting input terminal (+), an inverting input terminal (−), and an output terminal.

The second voltage divider 134 may divide, through voltage-dividing nodes, the voltage between the upper and lower gamma reference voltages V1 and V11 from the first buffer part 133, thereby outputting gamma reference voltages V1, V2, V3, V4, V5, V6, V7, V8, V9, V10, and V11 having different voltage levels.

The second buffer part 135 may transfer the gamma reference voltages V1, V2, V3, V4, V5, V6, V7, V8, V9, V10, and V11 output from the second voltage divider 134.

The third voltage divider 136 may divide, through voltage-dividing nodes, the voltage between the gamma reference voltages V1, V2, V3, V4, V5, V6, V7, V8, V9, V10, and V11 output from the second buffer part 135, thereby outputting gamma compensation voltages for each grayscale, i.e., grayscale voltages.

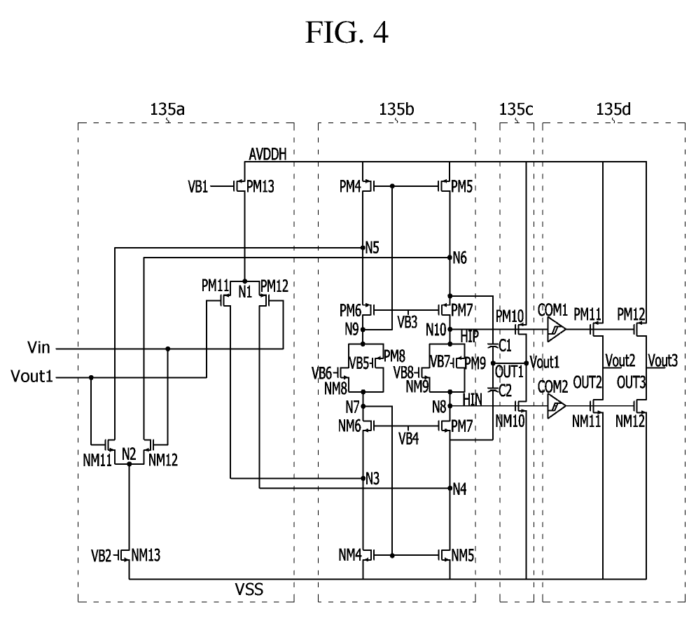

FIG. 4 is an equivalent circuit diagram illustrating a circuit configuration of the second buffer part shown in FIG. 3.

Referring to FIG. 4, the second buffer part 135 according to an embodiment of the present disclosure may include an input part 135a, an amplification part 135b, an output part 135c, and a stabilizer 135d.

The input part 135a may include an eleventh PMOS transistor PM11, a twelfth PMOS transistor PM12, an eleventh NMOS transistor NM11, a twelfth NMOS transistor NM12, a thirteenth PMOS transistor PM13, and a thirteenth NMOS transistor NM13.

The eleventh PMOS transistor PM11 is controlled by an output voltage Vout1, and includes a gate electrode to which the output voltage Vout1 is applied, a first electrode connected to a first node N1, and a second electrode connected to a third node N3.

The twelfth PMOS transistor PM12 is controlled by an input voltage Vin, and includes a gate electrode to which the input voltage Vin is applied, a first electrode connected to the first node N1, and a second electrode connected to a fourth node N4.

When the eleventh PMOS transistor PM11 is turned on by the output voltage Vout1, it supplies a high-potential voltage AVDDH to the third node N3, and when the twelfth PMOS transistor PM12 is turned on by the input voltage Vin, it supplies the high-potential voltage AVDDH to the fourth node N4.

The eleventh NMOS transistor NM11 is controlled by the output voltage Vout1, and includes a gate electrode to which the output voltage Vout1 is applied, a first electrode connected to a fifth node N5, and a second electrode connected to a second node N2.

The twelfth NMOS transistor NM12 is controlled by the input voltage Vin, and includes a gate electrode to which the input voltage Vin is applied, a first electrode connected to a sixth node N6, and a second electrode connected to the second node N2.

When the eleventh NMOS transistor NM11 is turned on by the output voltage Vout1, it discharges the fifth node N5 to a low-potential voltage VSS, and when the twelfth NMOS transistor NM12 is turned on by the input voltage Vin, it discharges the sixth node N6 to the low-potential voltage VSS.

The thirteenth PMOS transistor PM13 is controlled by a first bias voltage VB1, and includes a gate electrode to which the first bias voltage VB1 is applied, a first electrode to which the high-potential voltage AVDDH is applied, and a second electrode connected to the first node N1.

The thirteenth NMOS transistor NM13 is controlled by a second bias voltage VB2, and includes a gate electrode to which the second bias voltage VB2 is applied, a first electrode connected to the second node N2, and a second electrode to which the low-potential voltage VSS is applied.

When the thirteenth PMOS transistor PM13 is turned on by the first bias voltage VB1, it supplies the high-potential voltage AVDDH to the first node N1, and when the thirteenth NMOS transistor NM13 is turned on by the second bias voltage VB2, it supplies the low-potential voltage VSS to the second node N2.

The amplification part 135b may amplify currents at the third through sixth nodes N3 to N6 depending on the difference between the input voltage Vin and the output voltage Vout1, and may generate a first control voltage HIP and a second control voltage HIN at a tenth node N10 and an eighth node N8, respectively. The amplification part 135b may include a fourth PMOS transistor PM4, a fifth PMOS transistor PM5, a sixth PMOS transistor PM6, a seventh PMOS transistor PM7, an eighth PMOS transistor PM8, a ninth PMOS transistor PM9, a fourth NMOS transistor NM4, a fifth NMOS transistor NM5, a sixth NMOS transistor NM6, a seventh NMOS transistor NM7, an eighth NMOS transistor NM8, and a ninth NMOS transistor NM9.

The fourth PMOS transistor PM4 is controlled by the voltage at the ninth node N9, and includes a gate electrode connected to the ninth node N9, a first electrode to which the high-potential voltage AVDDH is applied, and a second electrode connected to the fifth node N5.

The fifth PMOS transistor PM5 is controlled by the voltage at the ninth node N9, and includes a gate electrode connected to the ninth node N9, a first electrode to which the high-potential voltage AVDDH is applied, and a second electrode connected to the sixth node N6.

The sixth PMOS transistor PM6 is controlled by a third bias voltage VB3, and includes a gate electrode to which the third bias voltage VB3 is applied, a first electrode connected to the fifth node N5, and a second electrode connected to the ninth node N9.

The seventh PMOS transistor PM7 is controlled by the third bias voltage VB3, and includes a gate electrode to which the third bias voltage VB3 is applied, a first electrode connected to the sixth node N6, and a second electrode connected to the tenth node N10.

The eighth PMOS transistor PM8 is controlled by a fifth bias voltage VB5, and includes a gate electrode to which the fifth bias voltage VB5 is applied, a first electrode connected to the ninth node N9, and a second electrode connected to a seventh node N7.

The ninth PMOS transistor PM9 is controlled by a seventh bias voltage VB7, and includes a gate electrode to which the seventh bias voltage VB7 is applied, a first electrode connected to the tenth node N10, and a second electrode connected to an eighth node N8.

The fourth NMOS transistor NM4 is controlled by the voltage at the seventh node N7, and includes a gate electrode connected to the seventh node N7, a first electrode connected to the third node N3, and a second electrode to which the low-potential voltage VSS is applied.

The fifth NMOS transistor NM5 is controlled by the voltage at the seventh node N7, and includes a gate electrode connected to the seventh node N7, a first electrode connected to the fourth node N4, and a second electrode to which the low-potential voltage VSS is applied.

The sixth NMOS transistor NM6 is controlled by a fourth bias voltage VB4, and includes a gate electrode to which the fourth bias voltage VB4 is applied, a first electrode connected to the seventh node N7, and a second electrode connected to the third node N3.

The seventh NMOS transistor NM7 is controlled by the fourth bias voltage VB4, and includes a gate electrode to which the fourth bias voltage VB4 is applied, a first electrode connected to the eighth node N8, and a second electrode connected to the fourth node N4.

The eighth NMOS transistor NM8 is controlled by a sixth bias voltage VB6, and includes a gate electrode to which the sixth bias voltage VB6 is applied, a first electrode connected to the ninth node N9, and a second electrode connected to the seventh node N7.

The ninth NMOS transistor NM9 is controlled by an eighth bias voltage VB8, and includes a gate electrode to which the eighth bias voltage VB8 is applied, a first electrode connected to the tenth node N10, and a second electrode connected to the eighth node N8.

The output part 135c may perform a pull-up operation and a pull-down operation in accordance with the first and second control voltages HIP and HIN, and thereby output an output voltage Vout1 that follows the input voltage Vin to a first output node OUT1. The output part 135c may include a tenth PMOS transistor PM10, a tenth NMOS transistor NM10, a first capacitor C1, and a second capacitor C2.

The tenth PMOS transistor PM10 is a pull-up transistor controlled by the voltage at the tenth node N10, and includes a gate electrode connected to the tenth node N10, a first electrode to which the high-potential voltage AVDDH is applied, and a second electrode connected to the first output node OUT1.

The tenth NMOS transistor NM10 is a pull-down transistor controlled by the voltage at the eighth node N8, and includes a gate electrode connected to the eighth node N8, a first electrode connected to the first output node OUT1, and a second electrode to which the low-potential voltage VSS is applied.

The first capacitor C1 is connected between the sixth node N6 and the first output node OUT1. The second capacitor C2 is connected between the fourth node N4 and the first output node OUT1. The first capacitor C1 and the second capacitor C2 may stabilize the output voltage Vout1 output through the first output node OUT1 so as not to oscillate when the output voltage Vout1 rises or falls.

The stabilizer 135d may rapidly stabilize fluctuation of a gamma reference voltage due to variations in the input voltage Vin. The stabilizer 135d may include a first comparator COM1, a second comparator COM2, an eleventh PMOS transistor PM11, an eleventh NMOS transistor NM11, a twelfth PMOS transistor PM12, and a twelfth NMOS transistor NM12.

The first comparator COM1 may sense the voltage at the tenth node N10, i.e., the first control voltage HIP, and convert it into a first pulse wave HIP_EN for output. The first comparator COM1 may be connected between the tenth node N10 and the gate electrode of the eleventh PMOS transistor PM11.

The second comparator COM2 may sense the voltage at the eighth node N8, i.e., the second control voltage HIN, and convert it into a second pulse wave HIN_EN for output. The second comparator COM2 may be connected between the eighth node N8 and the gate electrode of the eleventh NMOS transistor NM11.

The first comparator COM1 and the second comparator COM2 may be comparators having hysteresis characteristics, and may output a logic high voltage when a voltage equal to or greater than a predetermined threshold value is input, and output a logic low voltage when a voltage less than the threshold value is input. The first comparator COM1 and the second comparator COM2 may be implemented as, for example, Schmitt triggers, but are not limited thereto.

The eleventh PMOS transistor PM11 is a pull-up transistor controlled by the voltage of the first pulse wave (HIP_EN) output from the first comparator COM1, and includes a gate electrode connected to the tenth node N10, a first electrode to which the high-potential voltage AVDDH is applied, and a second electrode connected to a second output node OUT2.

The eleventh NMOS transistor NM11 is a pull-down transistor controlled by the voltage of the second pulse wave HIN_EN output from the second comparator COM2, and includes a gate electrode connected to the eighth node N8, a first electrode connected to the second output node OUT2, and a second electrode to which the low-potential voltage VSS is applied.

The twelfth PMOS transistor PM12 is a pull-up transistor controlled by the voltage of the first pulse wave HIP_EN output from the first comparator COM1, and includes a gate electrode connected to the tenth node N10, a first electrode to which the high-potential voltage AVDDH is applied, and a second electrode connected to a third output node OUT3.

The twelfth NMOS transistor NM12 is a pull-down transistor controlled by the voltage of the second pulse wave HIN_EN output from the second comparator COM2, and includes a gate electrode connected to the eighth node N8, a first electrode connected to the third output node OUT3, and a second electrode to which the low-potential voltage VSS is applied.

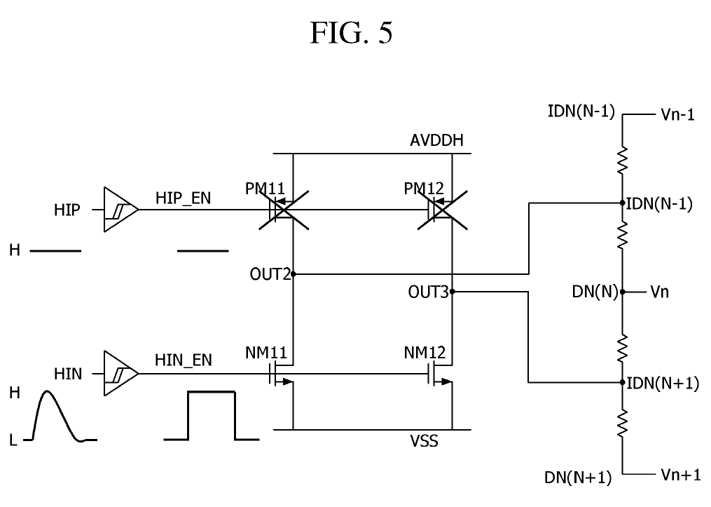

FIGS. 5 to 8 are diagrams for explaining the operating principle of the stabilizer shown in FIG. 4.

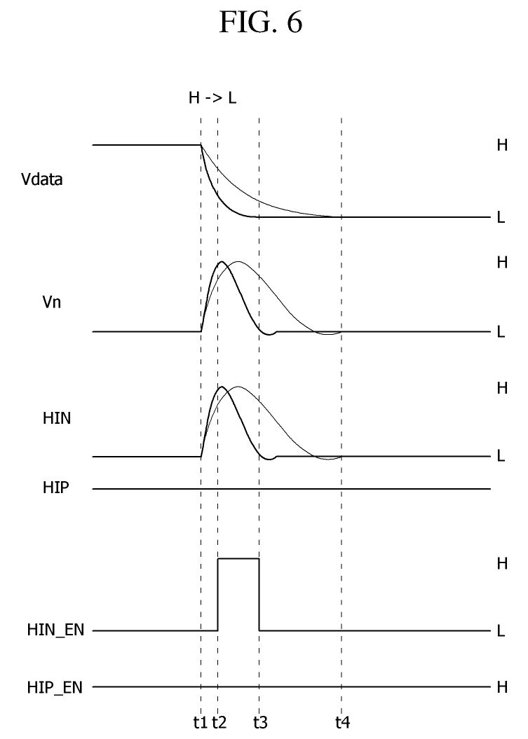

Referring to FIGS. 5 and 6, when the grayscale of the input image decreases, the input voltage VIN falls and becomes lower than the output voltage Vout1, which causes the gamma reference voltage to swing in the positive (+) direction, thereby increasing the second control voltage HIN to be applied as a gate-on voltage.

During this period, in the stabilizer 135d, the pull-up transistors, i.e., the eleventh PMOS transistor PM11 and the twelfth PMOS transistor PM12, are turned off, whereas the pull-down transistors, i.e., the eleventh NMOS transistor NM11 and the twelfth NMOS transistor NM12, are turned on to perform a pull-down operation, so that the voltages at the (N-1)th intermediate voltage-dividing node IDN(N-1) and the (N+1)th intermediate voltage-dividing node IDN(N+1) decrease with respect to the Nth voltage-dividing node DN(N) at which the Nth gamma reference voltage Vn is output, thereby decreasing the output voltage.

The (N-1)th intermediate voltage-dividing node IDN(N-1) is located between the (N-1)th voltage-dividing node DN(N-1) and the Nth voltage-dividing node DN(N), and the (N+1)th intermediate voltage-dividing node IDN(N+1) is located between the Nth voltage-dividing node DN(N) and the (N+1)th voltage-dividing node DN(N+1).

That is, when the eleventh NMOS transistor NM11 and the twelfth NMOS transistor NM12 are turned on, a sink current is generated at the (N-1)th intermediate voltage-dividing node IDN(N-1) and the (N+1)th intermediate voltage-dividing node IDN(N+1), so that the voltages at the (N-1)th intermediate voltage-dividing node IDN(N-1) and the (N+1)th intermediate voltage-dividing node IDN(N+1) decrease.

Accordingly, due to the voltage variation at the (N-1)th intermediate voltage-dividing node IDN(N-1) and the (N+1)th intermediate voltage-dividing node IDN(N+1), the settling time for the Nth gamma reference voltage Vn to return to its original voltage is shortened, which in turn also shortens the settling time for the output voltage Vout1.

For example, as shown in FIG. 6, the settling time for the Nth gamma reference voltage Vn is shortened from t4 to t3, and the settling time for the output voltage Vout1 is also shortened from t4 to t3.

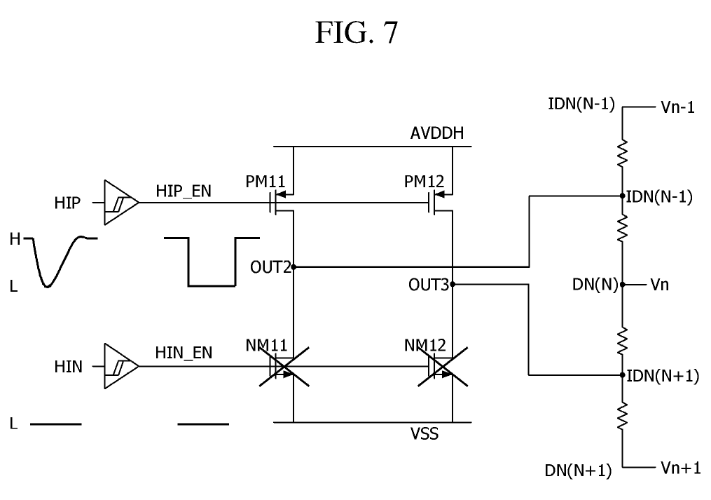

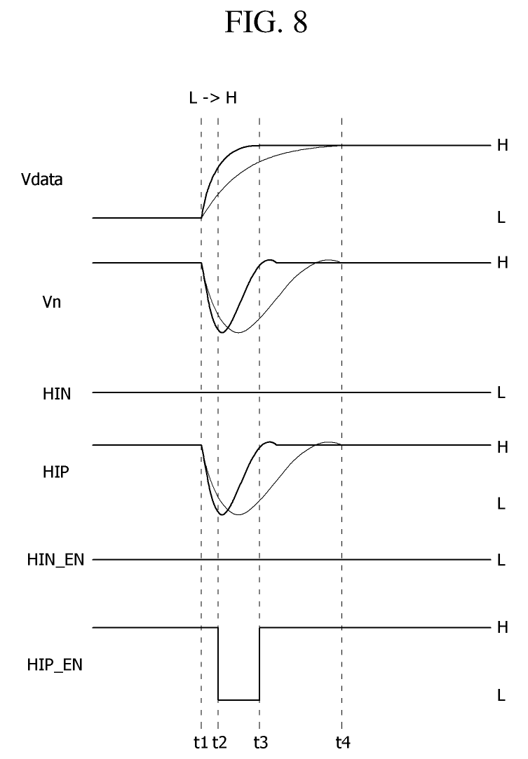

Referring to FIGS. 7 and 8, when the grayscale of the input image increases, the input voltage VIN rises and becomes greater than the output voltage Vout1, which causes the gamma reference voltage to swing in the negative (−) direction, thereby decreasing the first control voltage HIP to be applied as a gate-on voltage.

During this period, in the stabilizer 135d, the pull-down transistors, i.e., the eleventh NMOS transistor NM11 and the twelfth NMOS transistor NM12, are turned off, whereas the pull-up transistors, i.e., the eleventh PMOS transistor PM11 and the twelfth PMOS transistor PM12, are turned on to perform a pull-up operation, so that the voltages at the (N-1)th intermediate voltage-dividing node IDN(N-1) and the (N+1)th intermediate voltage-dividing node IDN(N+1) increase with respect to the Nth voltage-dividing node DN(N) at which the Nth gamma reference voltage Vn is output, thereby increasing the output voltage.

That is, when the eleventh PMOS transistor PM11 and the twelfth PMOS transistor PM12 are turned on, a source current is generated at the (N-1)th intermediate voltage-dividing node IDN(N-1) and the (N+1)th intermediate voltage-dividing node IDN(N+1), so that the voltages at the (N-1)th intermediate voltage-dividing node IDN(N-1) and the (N+1)th intermediate voltage-dividing node IDN(N+1) increase.

Accordingly, due to the voltage variation at the (N-1)th intermediate voltage-dividing node IDN(N-1) and the (N+1)th intermediate voltage-dividing node IDN(N+1), the settling time for the Nth gamma reference voltage Vn to return to its original voltage is shortened, which in turn also shortens the settling time for the output voltage Vout1.

For example, as shown in FIG. 8, the settling time for the Nth gamma reference voltage Vn is shortened from t4 to t3, and the settling time for the output voltage Vout1 is also shortened from t4 to t3.

Although the embodiments of the present disclosure have been described in more detail with reference to the accompanying drawings, the present disclosure is not necessarily limited to such embodiments, and may be modified in various ways within the scope without departing from the technical spirit of the present disclosure. Therefore, the embodiments disclosed in the present specification are provided not to limit the technical spirit of the present disclosure, but to describe it, and the scope of the technical spirit of the present disclosure is not limited by these embodiments. Therefore, the embodiments described above should be understood in all respects as illustrative and not restrictive. The scope of protection of the present disclosure should be interpreted by the claims, and all technical ideas within an equivalent range thereof shall be construed to be within the scope of rights of the present disclosure.

What is claimed is:

1. A gamma voltage generation circuit comprising:
a first voltage divider configured to output a plurality of voltages having different voltage levels between a high-potential reference voltage and a low-potential reference voltage;
a multiplexer part configured to select an upper gamma reference voltage and lower gamma reference voltages from the voltages divided by the first voltage divider;
a first buffer part configured to transfer the upper and lower gamma reference voltages selected by the multiplexer part;
a second voltage divider configured to output voltages having different voltage levels between the upper gamma reference voltage and the lower gamma reference voltages transferred by the first buffer part;
a second buffer part configured to transfer gamma reference voltages from the voltages divided by the second voltage divider; and
a third voltage divider configured to output grayscale voltages having different voltage levels between the gamma reference voltages transferred by the second buffer part,
wherein the second buffer part includes a stabilizer configured to generate a sink current or a source current at an (N-1)th (where N is a natural number) intermediate voltage-dividing node and an (N+1)th intermediate voltage-dividing node with respect to an Nth voltage-dividing node at which an Nth gamma reference voltage is output, whenever an input image changes.

2. The gamma voltage generation circuit according to claim 1, wherein the second buffer part further includes an output part configured to output the Nth gamma reference voltage through a first output node connected to the Nth voltage-dividing node, using a pull-up transistor controlled by a first control voltage and a pull-down transistor controlled by a second control voltage, and
wherein the stabilizer includes:
a first transistor and a second transistor configured to generate the sink current or the source current through a second output node connected to the (N-1)th intermediate voltage-dividing node; and
a third transistor and a fourth transistor configured to generate the sink current or the source current through a third output node connected to the (N+1)th intermediate voltage-dividing node.

3. The gamma voltage generation circuit according to claim 2, wherein the pull-up transistor, the first transistor, and the third transistor are p-channel transistors, and the pull-down transistor, the second transistor, and the fourth transistor are n-channel transistors.

4. The gamma voltage generation circuit according to claim 2, wherein:
the pull-up transistor includes a gate electrode to which the first control voltage is applied, a first electrode to which a high-potential voltage is applied, and a second electrode connected to the first output node, and
the pull-down transistor includes a gate electrode to which the second control voltage is applied, a first electrode connected to the first output node, and a second electrode to which a low-potential voltage is applied.

5. The gamma voltage generation circuit according to claim 2, wherein the stabilizer further includes:
a first comparator configured to convert the first control voltage into a first pulse wave and apply the converted first pulse wave to the first transistor and the third transistor; and
a second comparator configured to convert the second control voltage into a second pulse wave and apply the converted second pulse wave to the second transistor and the fourth transistor.

6. The gamma voltage generation circuit according to claim 5, wherein the first comparator and the second comparator are Schmitt triggers.

7. The gamma voltage generation circuit according to claim 5, wherein:
the first transistor includes a gate electrode to which the first pulse wave is applied, a first electrode to which a high-potential voltage is applied, and a second electrode connected to the second output node,
the second transistor includes a gate electrode to which the second pulse wave is applied, a first electrode connected to the second output node, and a second electrode to which a low-potential voltage is applied,
the third transistor includes a gate electrode to which the first pulse wave is applied, a first electrode to which the high-potential voltage is applied, and a second electrode connected to the third output node, and
the fourth transistor includes a gate electrode to which the second pulse wave is applied, a first electrode connected to the third output node, and a second electrode to which the low-potential voltage is applied.

8. The gamma voltage generation circuit according to claim 1, wherein:
the (N-1)th intermediate voltage-dividing node is located between the Nth voltage-dividing node and the (N-1)th voltage-dividing node at which an (N-1)th gamma voltage is output, and
the (N+1)th intermediate voltage-dividing node is located between the Nth voltage-dividing node and the (N+1)th voltage-dividing node at which an (N+1)th gamma voltage is output.

9. The gamma voltage generation circuit according to claim 1, wherein the stabilizer generates the sink current at each of the (N-1)th intermediate voltage-dividing node and the (N+1)th intermediate voltage-dividing node when the grayscale of the input image decreases.

10. The gamma voltage generation circuit according to claim 1, wherein the stabilizer generates the source current at each of the (N-1)th intermediate voltage-dividing node and the (N+1)th intermediate voltage-dividing node when the grayscale of the input image increases.

11. A source driver circuit comprising:
a data driver configured to convert source data into data voltages based on gamma voltages; and
a gamma voltage generation circuit configured to generate the gamma voltages,
wherein the gamma voltage generation circuit includes:
a first voltage divider configured to output a plurality of voltages having different voltage levels between a high-potential reference voltage and a low-potential reference voltage;
a multiplexer part configured to select an upper gamma reference voltage and lower gamma reference voltages from the voltages divided by the first voltage divider;
a first buffer part configured to transfer the upper gamma reference voltage and the lower gamma reference voltages selected by the multiplexer part;
a second voltage divider configured to output voltages having different voltage levels between the upper gamma reference voltage and the lower gamma reference voltages transferred by the first buffer part;
a second buffer part configured to transfer gamma reference voltages from the voltages divided by the second voltage divider; and
a third voltage divider configured to output grayscale voltages having different voltage levels between the gamma reference voltages transferred by the second buffer part,
wherein the second buffer part includes a stabilizer configured to generate a sink current or a source current at an (N-1)th (where N is a natural number) intermediate voltage-dividing node and an (N+1)th intermediate voltage-dividing node with respect to an Nth voltage-dividing node at which an Nth gamma reference voltage is output, whenever an input image changes.

12. The source driver circuit according to claim 11, wherein the second buffer part further includes an output part configured to output the Nth gamma reference voltage through a first output node connected to the Nth voltage-dividing node, using a pull-up transistor controlled by a first control voltage and a pull-down transistor controlled by a second control voltage, and
wherein the stabilizer includes:
a first transistor and a second transistor configured to generate the sink current or the source current through a second output node connected to the (N-1)th intermediate voltage-dividing node; and
a third transistor and a fourth transistor configured to generate the sink current or the source current through a third output node connected to the (N+1)th intermediate voltage-dividing node.

13. The source driver circuit according to claim 12, wherein the pull-up transistor, the first transistor, and the third transistor are p-channel transistors, and the pull-down transistor, the second transistor, and the fourth transistor are n-channel transistors.

14. The source driver circuit according to claim 12, wherein:
the pull-up transistor includes a gate electrode to which the first control voltage is applied, a first electrode to which a high-potential voltage is applied, and a second electrode connected to the first output node, and
the pull-down transistor includes a gate electrode to which the second control voltage is applied, a first electrode connected to the first output node, and a second electrode to which a low-potential voltage is applied.

15. The source driver circuit according to claim 12, wherein the stabilizer further includes:
a first comparator configured to convert the first control voltage into a first pulse wave and apply the converted first pulse wave to the first transistor and the third transistor; and
a second comparator configured to convert the second control voltage into a second pulse wave and apply the converted second pulse wave to the second transistor and the fourth transistor.

16. The source driver circuit according to claim 15, wherein the first comparator and the second comparator are Schmitt triggers.

17. The source driver circuit according to claim 15, wherein:
the first transistor includes a gate electrode to which the first pulse wave is applied, a first electrode to which a high-potential voltage is applied, and a second electrode connected to the second output node,
the second transistor includes a gate electrode to which the second pulse wave is applied, a first electrode connected to the second output node, and a second electrode to which a low-potential voltage is applied,
the third transistor includes a gate electrode to which the first pulse wave is applied, a first electrode to which the high-potential voltage is applied, and a second electrode connected to the third output node, and
the fourth transistor includes a gate electrode to which the second pulse wave is applied, a first electrode connected to the third output node, and a second electrode to which the low-potential voltage is applied.

18. The source driver circuit according to claim 11, wherein:
the (N-1)th intermediate voltage-dividing node is located between the Nth voltage-dividing node and the (N-1)th voltage-dividing node at which an (N-1)th gamma voltage is output, and
the (N+1)th intermediate voltage-dividing node is located between the Nth voltage-dividing node and the (N+1)th voltage-dividing node at which an (N+1)th gamma voltage is output.

19. The source driver circuit according to claim 11, wherein the stabilizer generates the sink current at each of the (N-1)th intermediate voltage-dividing node and the (N+1)th intermediate voltage-dividing node when the grayscale of the input image decreases.

20. The source driver circuit according to claim 11, wherein the stabilizer generates the source current at each of the (N-1)th intermediate voltage-dividing node and the (N+1)th intermediate voltage-dividing node when the grayscale of the input image increases.
